(19) United States
(12) Patent Application Publication
(10) Pub. No.: US 2005/0225105 A1
(43) Pub. Date: Oct. 13, 2005

(54) Convertible road and rail wheel assembly

(76) Inventor: Damon Meyer, Ashland, OH (US)

Correspondence Address: LEYDIG VOIT & MAYER, LTD, 700 THIRTEENTH ST. NW, SUITE 300, WASHINGTON, DC, 20005-3960, US

(21) Appl. No.: 10/513,270

(22) PCT Filed: Feb. 20, 2003
(86) PCT No.: PCT/US03/04990

§ 371 Date: Nov. 2, 2004

Related U.S. Application Data
(60) Provisional application No. 60/382,566, filed on May 24, 2002.

(51) Int. Cl. B60B 19/02

(52) U.S. Cl. 295/8.5

(57) ABSTRACT

A self-propelled four-wheel vehicle (1) for travel on land and/or on rails includes four hubs (9) for mounting of wheels including tires (6) for travel on land, four rail wheels (7) for travel on a railway, and four coupling assemblies, for detachably connecting the rail wheels to, outwardly of, and spaced from, the hubs. A kit for converting the vehicle for travel on rails includes, for each hub (9) of the vehicle, a rail wheel adapter (25, 44) including a flange (26, 45) for fastening to a rail wheel (7) and an axle portion (24, 46) extending transverse to the flange, a vehicle wheel adapter (10, 40) including a flange (15, 41) for fastening to a hub of the land vehicle and an axle portion (21, 42) extending transverse to the flange, and a coupler (12, 13) for coupling the rail wheel adapter to the vehicle wheel adapter.

This application claims the benefit of U.S. Patent Application 60/382,566, filed May 24, 2002, the disclosure of which is incorporated herein by reference.

### FIELD OF THE INVENTION

This invention relates to vehicles that can travel on both land and on a railroad and to a kit for converting a land vehicle so that the vehicle can travel both on land and on a railroad.

### BACKGROUND OF THE INVENTION

For many years railroads have employed small vehicles for inspecting railroad tracks and for transporting maintenance crews to locations on railroad tracks where repair and/or maintenance is needed. Since only a few persons, a section crew, are required to perform many small maintenance tasks and inspections, small rail vehicles carrying a few persons to remote locations are needed. In most locations only a single railroad track is available so that, ideally, the vehicle transporting the section crew can be easily removed from railroad tracks at the site of maintenance to allow trains to pass. Likewise, the vehicle should be easily replaced on the tracks for return of the section crew or inspectors to a central location. Further, it is particularly desirable to enter a rail system at locations remote from central railroad yards. Many remote locations are most easily accessed by traveling on a highway to an intersection with railroad tracks, i.e., at a grade crossing. At the grade crossing the rail vehicle may be placed on the tracks for movement to the location of inspection and/or maintenance.

Historically, a vehicle referred to as a section car has been used to transport section crews. These vehicles are self-propelled vehicles that can travel only on railroad tracks. These section cars must be moved to a siding during maintenance to allow a train to pass or must be completely removed from the track. Various hydraulic devices have been used to assist crews in removing and replacing section cars on tracks, a very time consuming and inefficient process. Further, the hydraulic devices increase cost of the cars and their maintenance. Some section cars can be removed and replaced on rails manually, but this task requires substantial effort by the crew and puts the crew at risk of injury.

In recent years, conventional highway vehicles, such as pickup trucks and utility trucks, have been modified to travel both on rails, using rails wheels, and on highways using the conventional rubber tires of the vehicles. Special rail wheels are fitted to the front and rear of such vehicles. In general, the rail wheels simply ensure that the vehicle remains on the rails. The vehicle propulsion is provided through the rubber tires. The rubber tires may contact the rails or the rail wheels. In these vehicles, it is typically necessary to employ special wheels, altering the distance between tires mounted on an axle of the vehicle. Therefore, a distance that corresponds to the rail gauge, i.e., the separation between the rails, must separate the rubber tires. In other vehicles altered to travel on both highways and on rails, the propulsion system of the vehicle may have to be modified to drive the rail wheels. The modifications are relatively expensive. These vehicles employing both rubber tires and rail wheels can be placed on rails at grade crossings. However, substantial time is required to transfer the vehicle to rails since the vehicle must be turned perpendicular to the passage of vehicles on the intersecting highway. In addition, once these vehicles are at a location remote from a grade crossing, it is difficult, if not impossible, to remove the vehicle from the rails to allow a train to pass. This difficulty in keeping the track clear interferes with rail traffic, causing substantial inefficiency in railroad operations.

Numerous manufacturers make commercially available relatively small four-wheel rubber-tired vehicles, referred to as utility vehicles or all-terrain vehicles (ATV). While utility vehicles and ATVs have some significant differences, these vehicles all have four wheels, rubber tires, and are self-propelled, for example by an internal combustion engine. Because of these similarities, these vehicles are considered to be the same for the purposes of the following description. Manufacturers of such vehicles include John Deere, Honda, and Kawasaki. Many of these vehicles are intended for off-road use, i.e., traveling across open land. The off-road vehicles can, however, travel on public roads if properly licensed. The separation between the rubber tires on the front axle and on the rear axle of these utility vehicles and ATVs is narrower than most rail gauges. The vehicles are relatively lightweight, inexpensive, and readily obtained. Many of the vehicles can transport two or more persons as well as some cargo. Since these vehicles can readily travel across open land and are self-propelled, they are potentially useful in inspection of railroad track and in transporting inspectors and section crews to remote railroad track locations. However, the vehicles cannot be used directly in a railroad system.

It is known from U.S. Pat. No. 4,744,324 that ATVs can be adapted to uses other than land travel by altering the conventional rubber tires that are supplied with the vehicle. According to this patent, an ATV can be converted to an amphibious vehicle by replacing the conventional tires with balloon tires that function as floatation devices. In addition, each of the driven rear wheels of the ATV can have attached to it an additional floatation tire with paddles mounted on an axle extension between the pairs of rear wheels. Thus, when the rear wheels are driven, the paddles propel the modified ATV through a body of water.

U.S. Pat. Nos. 2,010,617 and 2,657,947 both show arrangements in which a rail wheel is combined with a rubber tire of a vehicle so that the vehicle may travel on both a highway and a railway. In both structures, the rubber tire is attached directly against the rail wheel and the rubber tire has a larger outside diameter than the rail wheel. In U.S. Pat. No. 2,010,617, the rubber tires are placed outwardly with respect to the rails. In U.S. Pat. No. 2,657,947, the rail wheels are located outwardly with respect to the rubber tires. Thus, the rubber tires are located between the two rails when the vehicle including this wheel structure is traveling on a railway. In both the structures described in the two patents, the spacing between the rubber tires mounted on a common axle must conform to the rail gauge. Therefore, adjusting vehicles with these wheel structures to different rail gauges is extremely complicated. Accordingly, each vehicle not originally manufactured for railway use and employing these two kinds of wheels requires special and expensive modification.

As shown by the prior art, there is clearly a need for a lightweight and inexpensive vehicle that can travel on both railways and land, and that can be easily removed from and replaced on a railway, even at locations remote from a grade crossing.

It is further desirable that such a vehicle can be readily modified for use with railways of different gauges and, if necessary, between land and rail use.

In meeting these needs, the invention provides a four-wheel self-propelled vehicle with vehicle wheels and rubber tires for traveling on land or a road and with rail wheels detachably mounted to, spaced from, and located outwardly of each of the vehicle wheels and having a gauge matching the gauge of a railway upon which the vehicle may travel.

The lightweight vehicle is readily placed on and removed from a railroad either at a grade crossing or at a location remote from a grade crossing.

In further meeting the need, the invention provides a kit for modifying a commercially available rubber-tired four-wheel vehicle. The kit provides a coupling assembly including a vehicle wheel adapter for mounting on the hubs of the vehicle that carry the wheels with rubber tires, and a rail wheel adapter for mounting on a rail wheel. The coupling assembly provides for coupling of the rail wheel and the vehicle wheel adapter, extending from the hub to a rail wheel. By providing a coupling arrangement of adjustable length, the vehicle including the rail wheels can easily be adjusted to operate on railroads having different rail gauges.

### SUMMARY OF THE INVENTION

According to one aspect of the invention, a self-propelled four-wheel vehicle for travel on land and on rails comprises four hubs for mounting of respective wheels including tires for travel of the vehicle on land, four rail wheels for traveling of the vehicle on rails of a railway, and four coupling assemblies, each coupling assembly respectively detachably connecting one of the rail wheels to, outwardly of, and spaced from, the corresponding hub.

A kit for detachably mounting rail wheels on hubs of a land vehicle for converting the land vehicle for travel on rails comprises a rail wheel adapter including a flange for fastening to a rail wheel and an axle portion extending transverse to the flange, a vehicle wheel adapter including a flange for fastening to a hub of a land vehicle and an axle portion extending transverse to the flange, and coupling means for coupling the axle portion of the rail wheel adapter to the axle portion of the vehicle wheel adapter.

### BRIEF DESCRIPTION OF THE DRAWINGS

FIG. 1 is a perspective view of a vehicle according to the invention;

FIG. 2 is a detail view of a rail wheel connected to a hub of a vehicle according to the invention and on which a rubber tire is mounted;

FIG. 3 is an exploded view of parts of a kit in accordance with the invention in combination with a vehicle wheel and a rail wheel;

FIG. 4 is a detail, perspective view of a rail wheel on which part of a kit according to the invention has been mounted;

FIGS. 5A and 5B are detail views of an alternative embodiment of parts of a kit according to the invention;

FIG. 6 is an exploded view of an alternative embodiment of a kit according to the invention;

FIGS. 7A and 7B are an exploded view and a partial, cross-sectional view of parts of a kit according to the invention; and

FIG. 8 is a perspective view of still another embodiment of the invention including a simplified electrical insulating arrangement.

In all figures, like elements are given the same reference numbers.

### DETAILED DESCRIPTION OF THE INVENTION

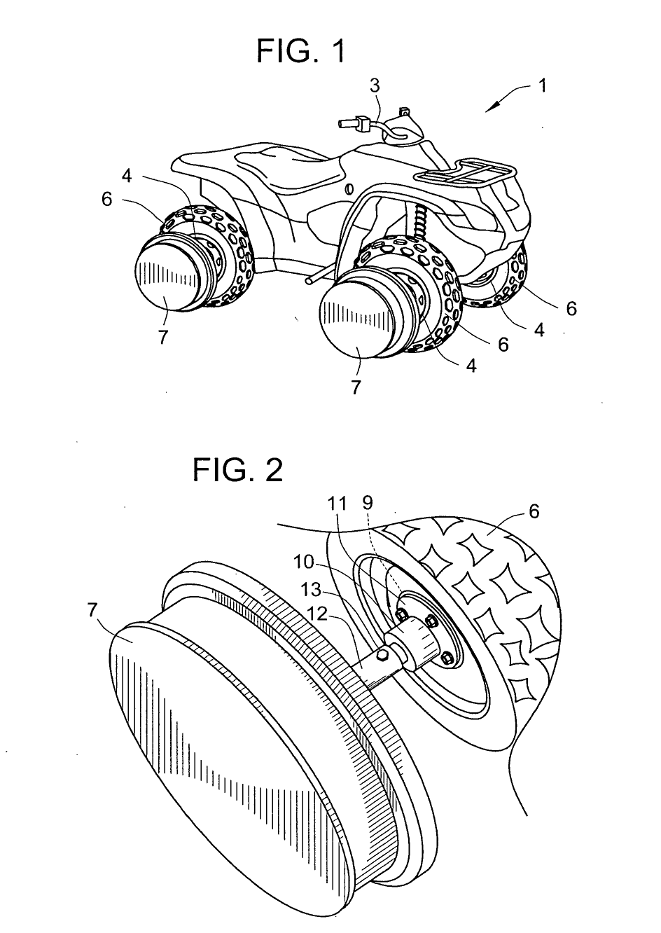

FIG. 1 is perspective view of a vehicle 1 according to the invention. The basic vehicle shown is an example of a commercially available gasoline-powered self-propelled ATV intended for a single rider. However, the invention encompasses other similar four-wheeled ATV and utility vehicles that accommodate two or more persons and that include space for carrying some cargo. The vehicle includes a steering mechanism that, in the illustrated embodiment, includes handlebars 3, for steering two of the four wheels 4 of the vehicle 1. In a conventional way, the handlebars control the angle of the front wheels. The rear wheels are not steered. As shown in FIG. 1, the tires 6 are mounted on each of the front and rear wheels 4, including the rear wheel that is not visible in FIG. 1. In addition, a rail wheel 7 is mounted on each of the hubs 9 (not visible in FIG. 1) of the axles of the vehicle. The front and rear wheels 4 are also mounted on the respective hubs 9. The wheels 4 and the tires 6 are not essential to a land vehicle converted to railway use only. Many of the converting structures depicted here show the wheels 4 and the tires 6. However, it should be understood that the wheels and tires are not essential to the invention. A vehicle according to the invention may have only rail wheels. Such a vehicle can travel on land, or at least on a hard surface on land, although not as efficiently as when running on rubber tires.

In the illustrated embodiment, the tires 6 have a larger outside diameter than the rail wheels 7. Therefore, the vehicle can travel over land that is relatively smooth or a road with both the rail wheels 7 and the tires 6 attached to the vehicle. When the vehicle is traveling on rails, care must be exercised at grade crossings when the rail wheels 7 may be lifted from the rails by contact of the tires 6 with the road at the grade crossing. Likewise, switches or other railway appliances between rails may be contacted by the tires 6, and may lift the vehicle and the rail wheels 7 may move out of contact with the rails. When the vehicle is used on rails and is at a location remote from a grade crossing, this relationship between the size of the tires and the rail wheels may be exploited in easily removing the vehicle from the rails. For example, ramps may be placed between the rails so that the tires climb the ramps, lifting and disengaging the rail wheels from the rails, thereby facilitating removal of the vehicle from the rails. The same ramps can be employed in reverse, in returning the vehicle to the rails at a remote location. At a grade crossing, the vehicle can be easily placed on wheels simply by aligning the rail wheels with the rails and driving off the end of the grade crossing at the level of the intersecting road. The vehicle is derailed at a grade crossing in exactly the reverse procedure. Further, if the vehicle should derail, the tires provide support to the vehicle so it does not plunge between the rails and function as a guardrail to prevent the vehicle from leaving the rail roadbed while the vehicle is brought to a stop. The vehicle's sideward motion is limited because the rail is between the tire and the rail wheel.

It is apparent from FIG. 1 that the vehicle, when mounted on rails, is propelled by the same propulsion system that drives the wheels of the vehicle. Since the rail wheels 7 are directly fastened to the driven wheels of the vehicle there is no need to establish or maintain contact between the rails and the tires or to modify the spacing between the tires to propel the vehicle.

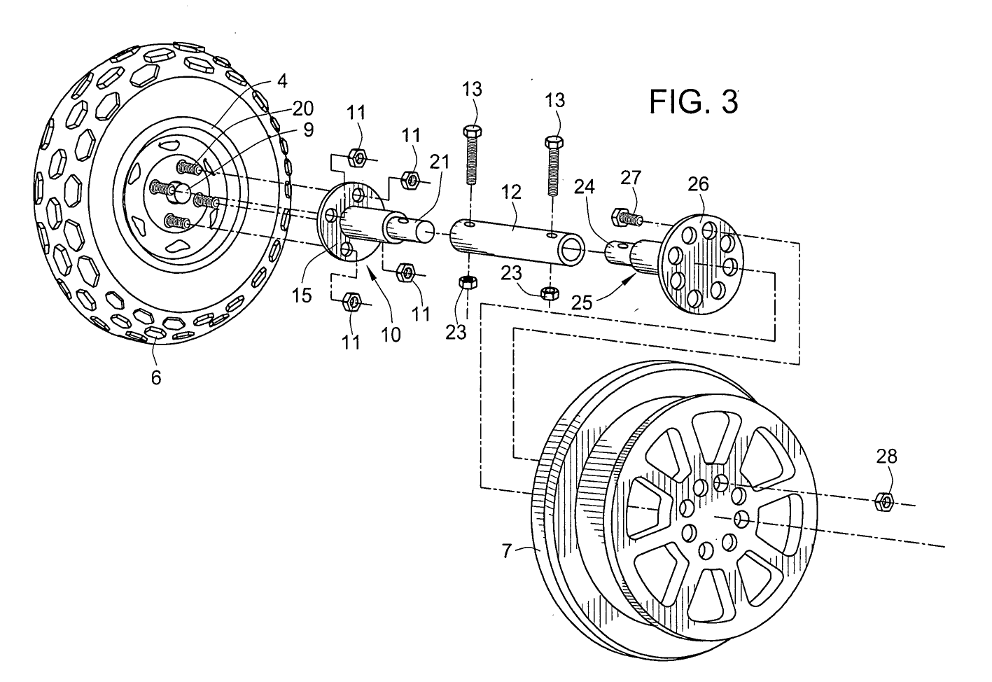

FIG. 2 is a detail view showing, in a perspective view, one example of a coupling between a tire 6 and a rail wheel 7. In the illustrated example, a coupling assembly includes a vehicle wheel adapter 10 fastened to the hub 9 at the end of an axle of the vehicle, using the existing studs 20 of the axle assembly of the vehicle and lug nuts 11. The vehicle wheel adapter 10 is fastened to a central coupler, an axle extension tube 12 that is part of the coupling assembly. The engagement is secured by a fastener, such as the bolt 13 and a nut, as described below.

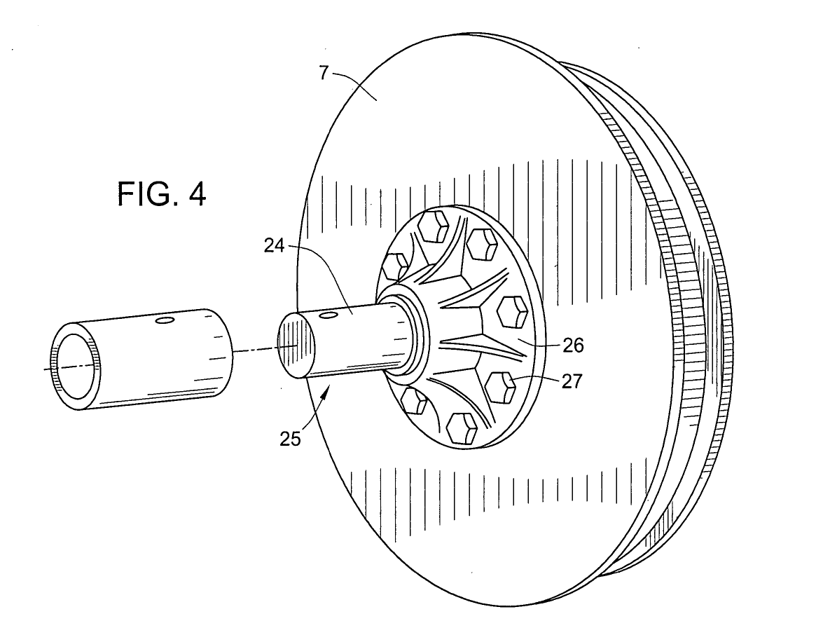

A more detailed view of the coupling assembly shown in the partial detail view of FIG. 2 is shown in the exploded view of FIG. 3. Turning to that FIG. 3, the tire 6 is shown mounted on the vehicle wheel 4 that, in turn, is mounted on the hub 9 of the axle. The studs 20 protrude from the hub 9 through holes in the wheel and are conventionally used to mount the wheel 4. The adapter 10 includes a flange 15, transverse to the axle and including openings for passage of the studs 20. The vehicle wheel adapter 10 is fastened to the hub 9 with the same lug nuts 11 used to mount the wheel 4. The vehicle wheel adapter 10 includes an axle portion, a shaft 21 extending transverse to the flange 15, that is received within the central coupler, the axle extension tube 12. The shaft 21 includes a hole that may be aligned with a similar hole in the axle extension tube 12 for passage of a bolt 13 that is secured with a nut 23. The bolt-passing holes are transverse to the axis of rotation of the wheel 4.

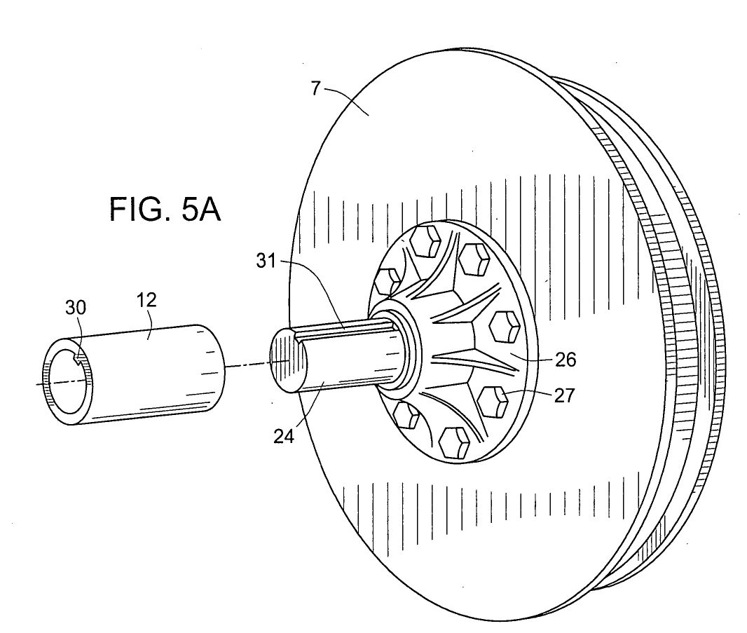

At the opposite end of the axle extension tube 12, a shaft 24, as an axle portion, protruding from a rail wheel adapter 25 is received within the axle extension tube. The shaft 24 is fixed within the axle extension tube with a bolt 13 and a nut 23, for example, passing through alignable holes within the axle extension tube and the shaft 24 of the rail wheel adapter 25. These holes are transverse to the axis of rotation of the wheel 4. The rail wheel adapter 25 includes a flange 26 transverse to the shaft 24. The flange 26 has a number of peripherally located holes that align with corresponding holes in the rail wheel 7. The aligned holes receive fasteners, such as bolts 27 and nuts 28 securing the rail wheel 7 to the rail wheel adapter 25. FIG. 4 shows this attachment in a perspective view.

The spacing between a pair of rail wheels 7 mounted on a front or rear axle of the vehicle 1 have a separation that depends upon the spacing between the vehicle wheels and the length of the coupling assembly, i.e., the lengths of the adapters 10 and 25 and of the axle extension tube 12 interposed between and coupling the adapters. Thus, the lengths of these articles are chosen so that the width between the mounted rail wheels 7 matches the gauge of a railway on which the vehicle is to be used. When the vehicle will be used on a single gauge railway, then it is desirable that, for the illustrated embodiment, that a single length central coupler, i.e., axle extension tube 12, be employed. However, by supplying multiple sets of axle extension tubes 12 of different lengths, vehicles suitable for use on different gauge railways can easily be assembled.

In order to convert a vehicle from land use only to use both on land and on a railway, it is only necessary to supply a kit of coupling assemblies to provide the connection between railway wheels 7 and hubs 9 of the land vehicle. In other words, a coupling assembly kit including a vehicle wheel adapter, a rail wheel adapter, an axle extension tube, a rail wheel, if needed, and fasteners for connecting these elements is all that is required to adapt each wheel of the vehicle for rail use. Although the fasteners illustrated in FIGS. 3 and 4 are all nuts and bolts, this illustration is not intended to exclude the use of other kinds of fasteners that provide sufficient shearing strength for transmitting the necessary torque between the vehicle wheels and the rail wheels. It is particularly useful in this embodiment and the embodiments described below to use fasteners that may quickly be released, such as pins held in place by cotter pins, for rapid attachment and detachment of rail wheels, provided strength and safety of the coupling is not impaired. As shown in the figures, if the vehicle is to be converted from land use to rail use exclusively by removing the tires and associated wheels, then a further adjustment or shim is needed. As shown in the drawings, when the wheel 4 with the tire 6 is mounted on the hub, part of the wheel is interposed between the hub and the vehicle wheel adapter. The distance between the rail wheels may be determined on this basis. However, if the vehicle wheel and tire are removed, the pair of rail wheels on one axle will move closer together by twice the thickness of one of the vehicle wheels. To maintain the correct rail gauge, either the coupling assemblies must be designed to account for this change in distance or shims must be installed between the hubs and the vehicle wheel adapters in place of the vehicle wheels.

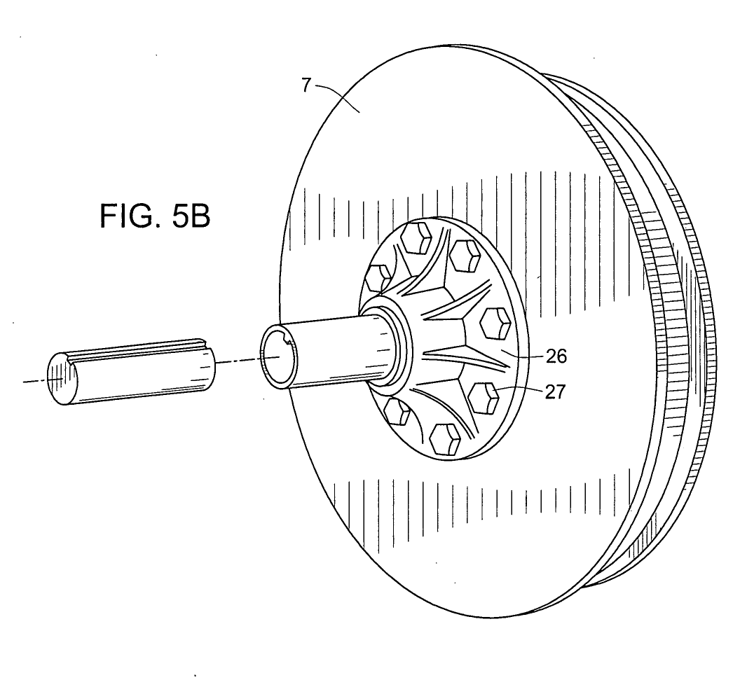

FIGS. 5A and 5B illustrate modifications of the axle extension tube 12 and the shaft 24 of the rail wheel adapter. As shown in FIG. 5A, the internal surface of the axle extension tube may include a spline 30 and the shaft 24 of the rail wheel adapter may include a complementary groove 31 for receiving the spline 30. The complementary groove and spline arrangement, which can be reversed as shown in FIG. 5B, provides improved torque transmission between the hub 9 and the rail wheel 7 as compared to the sole use of nuts and bolts, pins, or similar fasteners. It is also desirable to provide a spline groove on the shaft 21 of the vehicle wheel adapter 10, although that groove is not illustrated in FIG. 5A. FIG. 5B shows a complementary spline and groove arrangement when the coupling assembly includes a tubular rail wheel adapter and shaft on the vehicle wheel adapter as in the embodiments described below. Of course, the use of the spline and groove is only a single example of a structure that can be used to increase the engagement area of the parts of the coupling assembly that are fastened together. The invention encompasses other interlocking complementary structures intended to withstand shear forces and to transmit torque as the rail wheel is driven by rotation of the vehicle wheel.

In the embodiment described with respect to FIG. 3, each of the adapters of the coupling assembly includes an axle portion, a protruding shaft that is received within a central coupler, the tubular axle extension tube. However, this arrangement is not exclusive and the coupler assembly of the invention encompasses equivalent structures in which parts of the adapters are received within and secured to a central coupler and in which the adapters include tubular portions receiving a shaft located centrally between the two adapters, as in FIG. 5B. Further, as illustrated by embodiments described below, the central coupler can include a tubular portion at one end and a shaft at an opposite end coupled to complementary elements on the respective vehicle wheel and rail wheel adapters. As illustrated in FIG. 3, coupler assemblies according to the invention include the two separate adapters, one for the vehicle wheel and one for the rail wheel, connected to each other, either directly or with a central coupler disposed between, engaging, and fastened to the adapters.

When the vehicle including the rail wheels is operating on rails, there is no necessity of steering the vehicle with the handlebars 3 or whatever other steering device is provided. In fact, it is desirable, in order to avoid unintended derailing, to lock the steering device so that the steered wheels of the vehicle follow the path of the rails. The locking mechanism can be quite simple and include a strap connected between the body of the vehicle and the handlebars 3 or another steering control. Alternatively, a hinged fork can be attached to the body of the vehicle and merely pivoted into place, over the handlebars 3, or through another kind of steering device, such as a steering wheel, to prevent undue movement of the steering device. Further, one or more pins may be inserted into holes in a plate attached to a steering column and engaging or passing through a steering device, such as the handlebars 3, to lock the steering mechanism in place against turning by other than the rails on which the vehicle is traveling.

Although the illustrated vehicle includes tires that are larger in diameter than the rail wheels, the invention may encompass a vehicle in which the rail wheels are larger in diameter than the tires. In that event, the vehicle must be raised, for example by driving the vehicle up ramps, so that the rail wheels can be installed. Moreover, the rail wheels have to be removed before the vehicle is suitable for operating on a road or over land. While the attachment and removal of the rail wheels can be relatively simple, since the vehicle wheel adapters can remain in place even after the rail wheels have been removed, it is still preferred that the tires of the vehicle be larger in diameter than the rail wheels for travel on land.

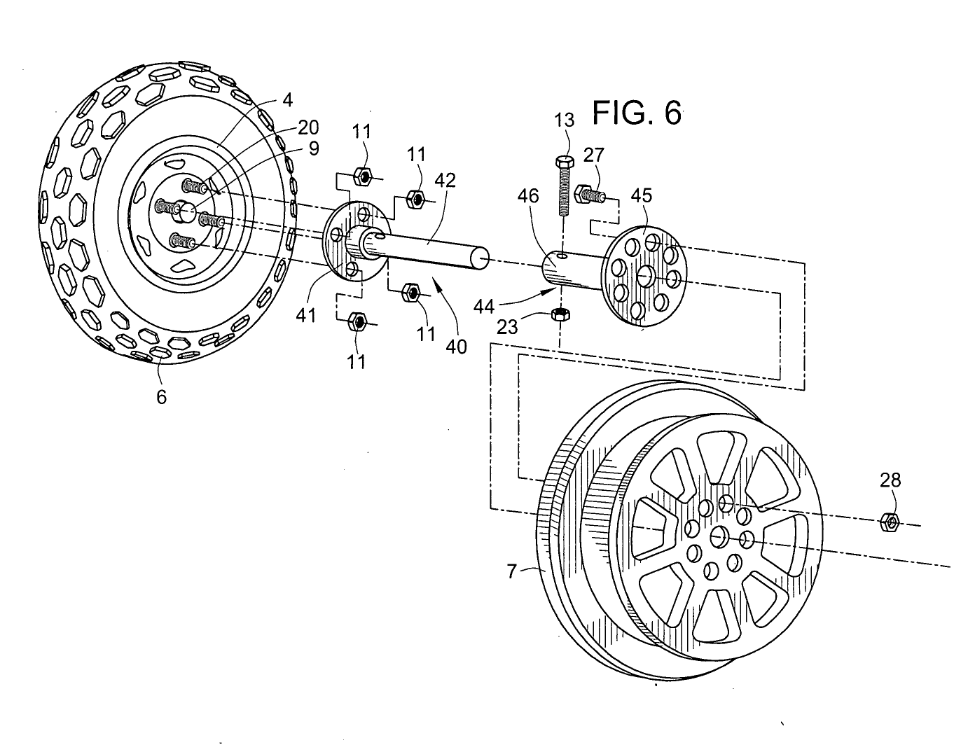

FIG. 6 illustrates an alternative coupler assembly for connecting the rail wheel 7 to the hub 9. This embodiment includes fewer parts than the embodiment illustrated in FIG. 3. Therefore, the kit for this coupler has fewer parts and is cheaper to manufacture. The embodiment of FIG. 6 includes a vehicle wheel adapter 40 having a flange 41 with a plurality of holes for alignment with the studs 20 of the vehicle hub 9. The studs 20 pass through corresponding holes of the flange 41 and lug nuts 11 are employed to fasten the vehicle wheel adapter 40 to the hub 9. The vehicle wheel adapter 40 includes a shaft 42 as an axle portion that extends into and engages a rail wheel adapter 44. The rail wheel adapter 44 includes a transverse flange 45 including holes that align with corresponding holes in the rail wheel 7. The rail wheel adapter 44 has a generally tubular protrusion 46, transverse to the flange 45, as an axle portion, and receives within a central opening the shaft 42 of the vehicle wheel adapter 40. Holes within the rail wheel adapter 44 and the shaft 43 and transverse to the axis of rotation of wheels are aligned so that the two adapters 40 and 44 are joined together by a fastener, such as the bolt 13 and the nut 23. An important feature of this embodiment is the tubular structure 46 of the rail wheel adapter 44 so that the shaft 43 of the vehicle wheel adapter can pass completely through the rail wheel adapter 44 and a central hole within the rail wheel 7. Although the depicted embodiment shows only a single transverse hole in the shaft 42, multiple holes can be provided along the shaft 42 so that the position of the rail wheel adapter 44 relative to the shaft 42 can be fixed at any one of several selectable positions. In that way, the distance between a pair of rail wheels at the front and back of the vehicle can be changed to easily accommodate different gauge railways. As in FIG. 3, the kit in FIG. 6, including the adapters 40 and 44 is shown as employing nuts and bolts as fasteners. Alternative fasteners can be employed. In addition, a structure providing improved torque transmission, such as the spline and complementary groove shown in FIGS. 5A and 5B, can be employed with the shaft 42 and the rail wheel adapter 44 of FIG. 6.

In the embodiment of FIG. 6, the vehicle wheel adapter 40 includes a protruding shaft and the rail wheel adapter has a protruding, at least partially tubular, portion 46 for receiving the shaft. This complementary engaging structure can, within the scope of the invention, be reversed, with the rail wheel adapter having a shaft received within a tubular vehicle wheel adapter to couple the vehicle and rail wheels.

The embodiments of the invention described above all work satisfactorily in achieving their purpose. However, in the previously described embodiments, the hubs 9 are in electrical contact with the attached rail wheel 7. In a vehicle in which the wheels on a front or rear axle assembly are in electrical communication, the attached rail wheels according to the invention will be in electrical communication. In many railways, an approaching rail car at a grade crossing, triggering warning signals and/or gates for road traffic, is detected by sensing establishment of an electrically conducting path between the rails. In other words, an approaching train establishes an electrical current between the rails. The flow of the current triggers the signals and/or gates at the grade crossing. It is not desirable or necessary for a vehicle according to the invention to trigger these signals since the vehicle, unlike a train, can slow down near a grade crossing and stop relatively quickly to wait for road traffic to clear.

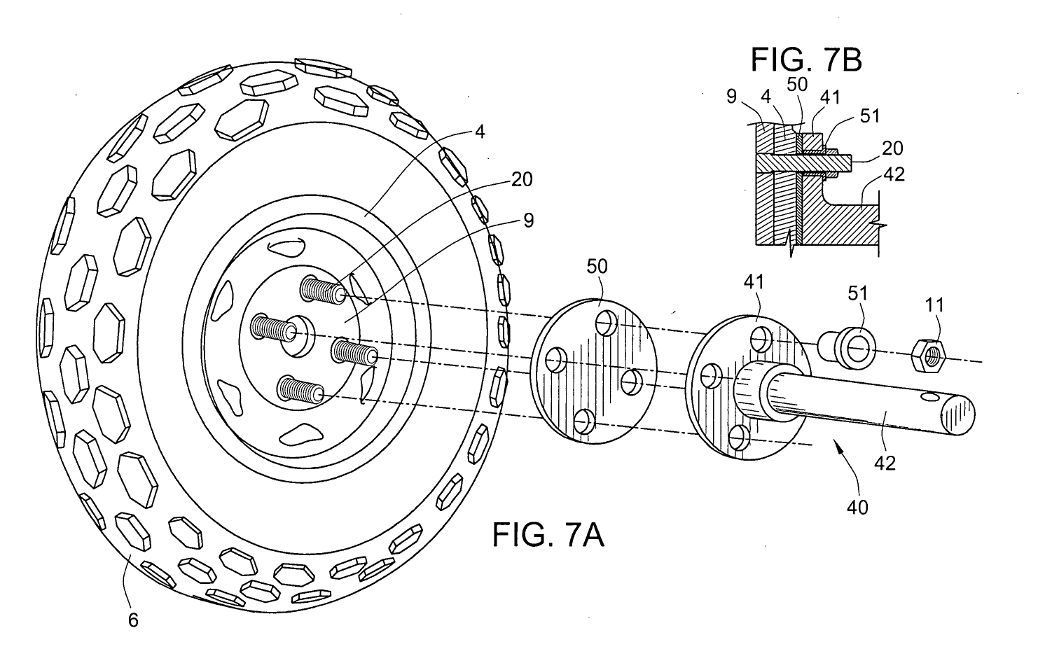

To avoid triggering traffic signals, it is necessary to electrically insulate the rail wheels 7 from the hubs 9. An assembly achieving that result is illustrated in FIGS. 7A and 7B. FIG. 7A shows a part of the embodiment of the structure illustrated in the exploded view of FIG. 6. FIG. 7B is a cross-sectional view of the parts illustrated in FIG. 7A, after assembly. The parts like numbered shown in FIGS. 7A and 7B are the same as those shown in FIG. 6. In addition, an electrically insulating disk 50, which may be a plastic or other somewhat rigid electrically insulating material that can tolerate the environmental conditions produced by the vehicle, is interposed between the vehicle wheel adapter flange 41 and the hub 9. The disk 50 includes holes matching the studs 20 extending from the hub 9 on which the wheel 6 is mounted. The disk 50 provides electrical insulation between the hub 9 and the flange 41 of that vehicle wheel adapter 40. To complete the desired electrical isolation, it is necessary that the nuts 42 not come in direct contact with the flange 41. To achieve that end, insulating bushings 51 are inserted within each of the holes in the flange 41, electrically insulating the studs 20 from the flange 41. The bushings 51 include collars on which the nuts 11 bear when the nuts are tightened, ensuring electrical insulation as illustrated in FIG. 7B. Even if the structures, i.e., shaft and tube, of the vehicle wheel adapter and rail wheel adapter are interchanged, the same electrically insulating disk and bushings can be used to achieve the same goal. Likewise, the insulating members, i.e., disk and bushings, can be provided at the rail wheel and rail wheel adapter to produce the same result.

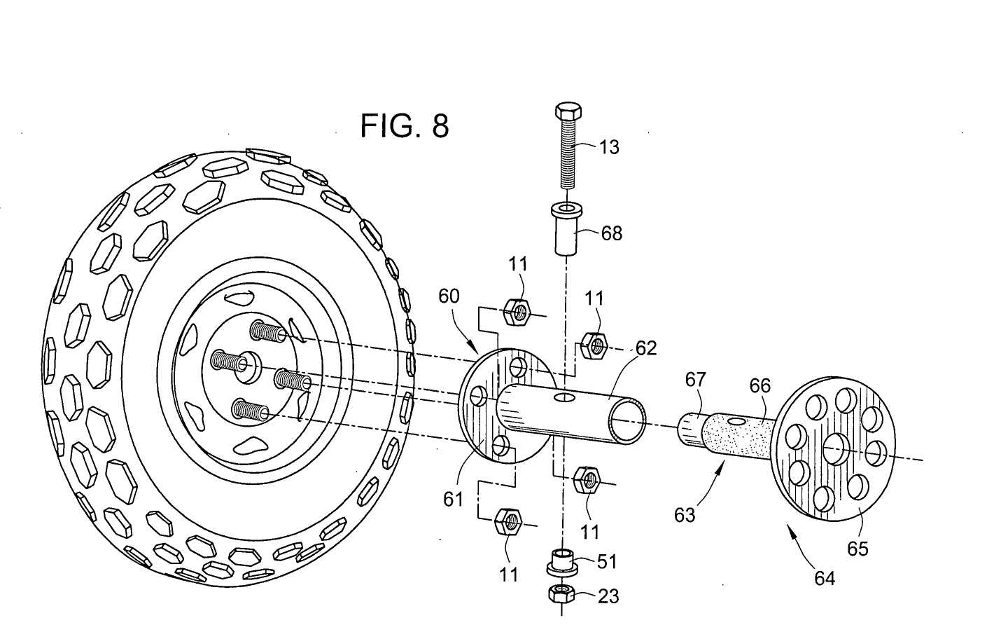

Another electrical insulation arrangement is illustrated in FIG. 8. For simplicity, in FIG. 8 the rail wheel 7 is not illustrated. The apparatus of FIG. 8 includes a vehicle wheel adapter 60 having a flange 61 with holes located for passage of the studs 20 extending from the hub 9. As in the apparatus of FIG. 6, the vehicle wheel adapter 60 is mounted on the hub 9 using lug nuts 11 engaging the studs 20 passing through the respective holes of the flange 61. The vehicle wheel adapter 60 also includes an extending tubular portion 62 that receives an insulated shaft 63 of a rail wheel adapter 64. The rail wheel adapter includes a flange 65 for bolting to the rail wheel 7 in the manner already described with respect to FIG. 6. The insulated shaft 63 extends perpendicular to the flange 65 and includes an electrically insulating sleeve 66 press-fit on a metal shaft 67. When the insulated shaft 63 is inserted within the tubular portion 62 of the vehicle wheel adapter, holes within and transverse to the tube and the shaft are aligned, a bolt 13 is inserted through the aligned holes and is secured with a nut 23. In order to insulate the bolt 13 from both the rail wheel adapter 64 and the vehicle wheel adapter 60, the bolt 13 is inserted through an electrically insulating bushing 67 that extends at least part way through the aligned holes in the tube 62 and the shaft 63. A bushing 51 completes the electrical insulation. The bushing 51 has a collar on which the bolt 13 rests when the bolt 13 and the nut 23 are tightened. The bolt 13 controls the position of the metal shaft 67 within the tube 62. Therefore, the end of the metal shaft 67 will not contact the hub 9 or any other metal part. Accordingly, no insulating disk, like the disk 50 of the embodiment of FIG. 6 is required in the embodiment of FIG. 8. The apparatus illustrated in FIG. 8 is simpler than the apparatus illustrated in FIG. 7A because it includes fewer parts and the electrically insulating sleeve 66 can be permanently attached to the rail wheel adapter 64.

The invention provides significant advantages over the prior art. Since the coupling assemblies include at least two principal members, the vehicle wheel adapter and the rail wheel adapter, the vehicle wheel adapter can be left in place, permanently, after the rail wheel and the rail wheel adapter are removed. Then, the rail wheel and the rail wheel adapter can be added and removed, as needed, quickly. Moreover, the way in which the two adapters couple to each other makes the conversion simple and easily accomplished by only one person.

The invention has been described with respect to certain preferred embodiments. However, the scope of the invention is determined solely by the following claims and encompasses not only the structures illustrated but also all modifications and additions within the spirit of the invention and equivalents thereof.

1. A self-propelled four-wheel vehicle for travel on land and on rails comprising:
four hubs for mounting of respective wheels including tires for travel of the vehicle on land;
four rail wheels for traveling of the vehicle on rails of a railway; and
four coupling assemblies, each coupling assembly respectively detachably connecting one of the rail wheels to, outwardly of, and spaced from, the corresponding hub.

2. The vehicle of claim 1 wherein at least two of the rail wheels are electrically isolated from the respective hubs to which they are connected by the respective coupling assemblies.

3. The vehicle of claim 1 wherein at least one of the coupling assemblies includes a vehicle wheel adapter having a flange fastened to one of the hubs and a rail wheel adapter including a flange fastened to one of the rail wheels, wherein the vehicle wheel adapter and the rail wheel adapter include complementary protruding axle portions fastened to each other.

4. The vehicle of claim 3 including a central coupler interposed between and fastened to the vehicle wheel adapter and the rail wheel adapter.

5. The vehicle of claim 4 wherein at least one end of the central coupler and at least one of the axle portions of the vehicle wheel adapter and the rail wheel adapter includes a spline and the other of the end of the central coupler and the at least one of the axle portions includes a groove complementary to and receiving the spline.

6. The vehicle of claim 4 wherein the central coupler includes at least one tubular end and at least one of the vehicle wheel adapter and the rail wheel adapter includes a protruding shaft as the axle portion protruding from the respective flange and received in and fastened to the tubular end of the central coupler.

7. The vehicle according to claim 6 wherein one of the tubular ends of the central coupler and the shaft includes a spline and the other of the tubular end and the shaft includes a spline groove complementary to and receiving the spline.

8. The vehicle according to claim 5 wherein each of the vehicle wheel adapter and the rail wheel adapter includes a respective shaft protruding from the respective flanges as an axle portion, and the central coupler is tubular and receives and is fastened to the shafts of the vehicle wheel adapter and the rail wheel adapter.

9. The vehicle of claim 3 wherein one of the vehicle wheel adapter and the rail wheel adapter includes a shaft as an axle portion and the other of the vehicle wheel adapter and the rail wheel adapter is at least partially tubular and receives and is fastened to the shaft.

10. The vehicle of claim 3 wherein the vehicle wheel adapter includes the shaft.

11. The vehicle of claim 10 including an electrically insulating disk interposed between the flange of the vehicle wheel adapter and the hub to which the vehicle wheel adapter is fastened, electrically insulating the flange from the hub.

12. A kit for detachably mounting rail wheels on hubs of a land vehicle for converting the land vehicle for travel on rails, the kit comprising:
a rail wheel adapter including a flange for fastening to a rail wheel and an axle portion extending transverse to the flange;
a vehicle wheel adapter including a flange for fastening to a hub of a land vehicle and an axle portion extending transverse to the flange; and
coupling means for coupling the axle portion of the rail wheel adapter to the axle portion of the vehicle wheel adapter.

13. The kit of claim 12 wherein one of the axle portions of the rail wheel adapter and of the vehicle wheel adapter is a shaft and the other of the axle portions of the rail wheel adapter and the vehicle wheel adapter is a tube receiving the shaft and the coupling means comprises fasteners for passing through the shaft and the tube when the rail wheel adapter is coupled to the vehicle wheel adapter.

14. The kit of claim 13 wherein one of the shaft and the tube includes a spline and the other of the shaft and the tube includes a groove complementary to the spline, for receiving the spline when the rail wheel adapter is coupled to the vehicle wheel adapter.

15. The kit of claim 12 wherein each of the axle portions of the rail wheel adapter and the vehicle wheel adapter comprises a shaft and the coupling means comprises a tubular central coupling member for receiving in respective ends the shafts of the rail wheel adapter and the vehicle wheel adapter, and fasteners for passing through the shafts and the central coupling member when the rail wheel adapter is coupled to the vehicle wheel adapter.

16. The kit of claim 15 wherein one of (i) the shafts of the rail Wheel adapter and the vehicle wheel adapter and (ii) at least one end of the central coupling member includes a spline and the other of (i) the shafts of the rail wheel adapter and the vehicle wheel adapter and (ii) at least one end of the central coupling member includes a groove complementary to the spline for receiving the spline when the shaft is coupled to the central coupling member.

17. The kit of claim 12 including an electrically insulating disk for interposition between a hub of the vehicle and the vehicle wheel adapter to electrically insulate the rail wheel adapter from the hub.

18. The kit of claim 17 wherein the coupling means includes fasteners and further including electrically insulating bushings for electrically insulating the fasteners from at least one of the rail wheel adapter and the vehicle wheel adapter.
